(19) United States
(12) Patent Application Publication
(10) Pub. No.: US 2016/0379033 A1
(43) Pub. Date: Dec. 29, 2016

(54) INTERACTION METHOD AND APPARATUS

(71) Applicant: BEIJING ZHIGU RUI TUO TECH CO., LTD, Hai Dian District, Beijing (CN)

(72) Inventor: Jia LIU, Beijing (CN)

(21) Appl. No.: 15/117,185

(22) PCT Filed: Dec. 29, 2014
(86) PCT No.: PCT/CN2014/095257

§ 371 Date: Aug. 6, 2016

(30) Foreign Application Priority Data
Mar. 14, 2014 (CN) 201410094068.0

(51) Int. Cl. G06K 9/00

(52) U.S. Cl. CPC G06K 9/0002; G06K 9/00067; H04L 63/0861

(57) ABSTRACT

Embodiments of the present application provide an interaction method and apparatus. The method includes: obtaining fingerprint information input by a user in an area in a user interface; determining a corresponding attribute of the area in the user interface; and obtaining data corresponding to the attribute and the fingerprint information. The embodiments of the present application provide an interaction solution.

### RELATED APPLICATION

The present international patent cooperative treaty (PCT) application claims the benefit of priority to Chinese Patent Application No. 201410094068.0, filed on Mar. 14, 2014, and entitled “Interaction Method and Apparatus”, which is hereby incorporated into the present international PCT application by reference herein in its entirety.

### TECHNICAL FIELD

Embodiments of the present application relate to the field of interaction technologies, and in particular, to an interaction method and apparatus.

### BACKGROUND

Biological features of human beings, including inherent physiological characteristics (such as fingerprints, face images, and irises) and behavioral characteristics (such as handwriting, voices, and gaits) of human bodies, are usually unique, measurable or automatically recognizable and verifiable, and are inherited or remain unchanged throughout one's life.

Various kinds of applications based on biological features of human beings, especially applications based on fingerprint information, have been used and gradually popularized in popular consumer electronics products such as computers and mobile phones.

### SUMMARY

In view of the above, an example objective of embodiments of the present application is to provide an interaction solution.

In order to achieve the foregoing objective, according to one example aspect of the embodiments of the present application, an interaction method is provided, including:

obtaining fingerprint information input by a user in an area in a user interface;

determining a corresponding attribute of the area in the user interface; and

obtaining data corresponding to the attribute and the fingerprint information.

In order to achieve the foregoing objective, according to another example aspect of the embodiments of the present application, an interaction apparatus is provided, including:

a fingerprint obtaining module, configured to obtain fingerprint information input by a user in an area in a user interface;

an attribute determining module, configured to determine a corresponding attribute of the area in the user interface; and

a data obtaining module, configured to obtain data corresponding to the attribute and the fingerprint information.

At least one technical solution of the above multiple technical solutions has the following example beneficial effects:

One or more embodiments of the present application provide an interaction solution, especially an interaction solution using fingerprint information, by obtaining fingerprint information input by a user in an area in a user interface, determining a corresponding attribute of the area in the user interface, and obtaining data corresponding to the attribute and the fingerprint information, thereby ensuring both accuracy and convenience.

### BRIEF DESCRIPTION OF THE DRAWINGS

FIG. 1a is an example flowchart of an embodiment of an interaction method according to the present application;

FIG. 1b and FIG. 1c are each an example schematic diagram of a direction of a fingerprint;

FIG. 2a is an example structural diagram of Embodiment 1 of an interaction apparatus according to the present application;

FIG. 2b is an example structural diagram of an embodiment of the embodiment shown in FIG. 2a;

FIG. 2c is an example structural diagram of another embodiment of the embodiment shown in FIG. 2a; and

FIG. 3 is an example structural diagram of Embodiment 2 of an interaction apparatus according to the present application.

### DETAILED DESCRIPTION

Embodiments of the present application are further described in detail below with reference to the accompanying drawings and embodiments. The following embodiments are used to describe the present application, but not used to limit the scope of the present application.

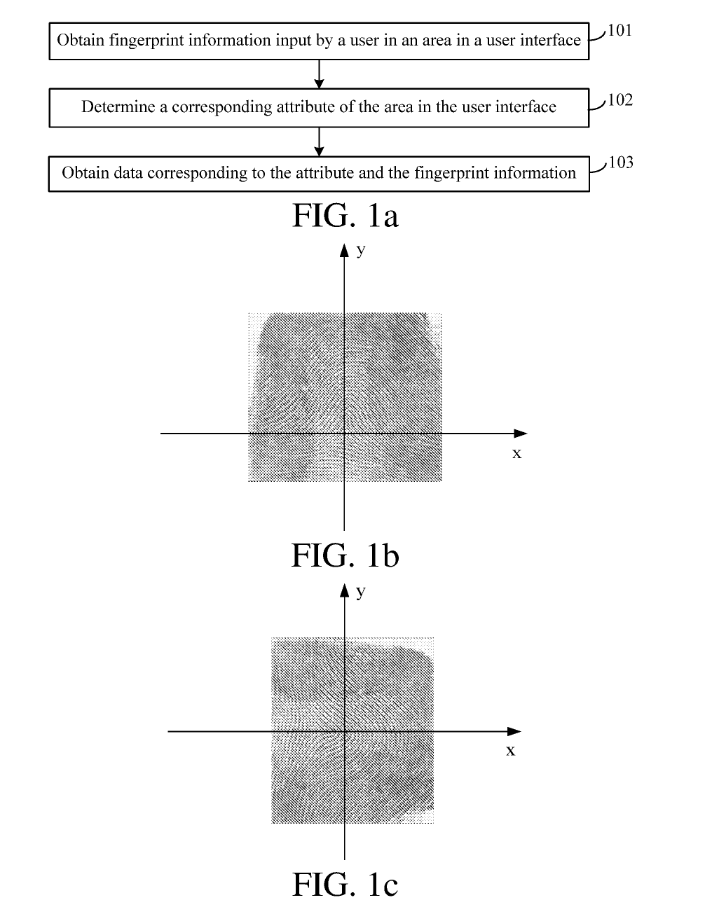

FIG. 1a is a flowchart of an embodiment of an interaction method according to the present application. As shown in FIG. 1a, this embodiment includes:

101. Obtain fingerprint information input by a user in an area in a user interface.

For example, an interaction apparatus, which executes this embodiment, obtains fingerprint information input by a user in an area in a user interface. Specifically, the interaction apparatus may be arranged in a user terminal in a form of hardware and/or software, or the interaction apparatus is a user terminal; the user terminal includes, but is not limited to: a mobile phone, a tablet computer, or a wearable device.

Specifically, the user interface includes a software part and/or a hardware part that is provided by the interaction apparatus or the user terminal in which the interaction apparatus is arranged and implements information exchange between a user and the interaction apparatus or the user terminal. In an optional embodiment, the user interface includes a page of an application. Specifically, the page is a page currently displayed by the interaction apparatus or the user terminal. In another optional embodiment, the user interface includes a page of an application and an input apparatus, such as a keyboard or a touch screen.

Specifically, the area is an input area. For example, the area may be an input box on a page, or a content editing area, such as a text editing area on an email writing page.

In an optional embodiment, the fingerprint information is input by touch. Correspondingly, a user performs touch input through a touch input apparatus provided by the interaction apparatus or the user terminal, and the touch input apparatus may be a touch display screen, a fingerprint recognizer, or the like. For example, the user terminal has a touch display screen, and the user can touch a position corresponding to an input area on a page currently displayed on the touch display screen with a finger. For another example, the user terminal has a keyboard that includes a fingerprint recognizer, and the user can touch the fingerprint recognizer of the keyboard when an input area on a currently displayed page is selected.

Specifically, the fingerprint information includes: at least one fingerprint. Each one of the at least one fingerprint is a complete fingerprint or a partial fingerprint. For example, when the user performs touch input with the fingertip of a finger, a fingerprint obtained by the interaction apparatus may be a partial fingerprint; when the user performs touch input with the finger pulp of a finger, a fingerprint obtained by the interaction apparatus may be a complete fingerprint. It should be noted that when the fingerprint information includes multiple fingerprints, the multiple fingerprints may include at least one complete fingerprint and at least one partial fingerprint at the same time, which is not limited by this embodiment.

In an optional embodiment, the fingerprint information further includes: a direction of each one of the at least one fingerprint. Usually, the direction refers to a relative direction of the fingerprint to the touch input apparatus. FIG. 1b and FIG. 1c are each a schematic diagram of a direction of a fingerprint. As shown in FIG. 1b and FIG. 1c, coordinate axes x and y in FIG. 1b and FIG. 1c are coordinate axes used for fingerprint acquisition by the touch input apparatus , the direction of the fingerprint in FIG. 1b is a y-axis direction, and the direction of the fingerprint in FIG. 1c is an x-axis direction.

Further, when the fingerprint information includes multiple fingerprints, the fingerprint information further includes: an arrangement of the multiple fingerprints. Specifically, the arrangement includes, but is not limited to: order of the arrangement, and a shape of the arrangement. The multiple fingerprints may be same fingerprints, for example, the multiple fingerprints are same fingerprints when the user touches the area with a same finger many times, and may also be different fingerprints, for example, the multiple fingerprints are different fingerprints when the user touches the area with multiple fingers at the same time, or when the user touches the area with multiple fingers one by one, which is not limited by this embodiment.

102. Determine a corresponding attribute of the area in the user interface.

Specifically, the attribute includes, but is not limited to, one of the followings: address, password, date, name, account, phone number, content, and file. The address attribute may further be classified into email address, mailing address, and so on; the account attribute may further be classified into login account, bank account, and so on.

For example, in a scenario where the user interface is a login page of an email, when the area is an email address input box, the corresponding attribute of the area in the user interface is email address; when the area is a password input box, the corresponding attribute of the area in the user interface is password; when the area is an attachment adding box, the corresponding attribute of the area in the user interface is file; and when the area is a content editing area, the corresponding attribute of the area in the user interface is content.

103. Obtain data corresponding to the attribute and the fingerprint information.

Usually, the data is data that matches the attribute. For example, when the corresponding attribute of the area in the user interface is phone number, the data is a phone number; when the corresponding attribute of the area in the user interface is email address, the data is an email address; when the corresponding attribute of the area in the user interface is content, the data is a piece of content, such as a text or a signature.

Specifically, the interaction apparatus obtains the data in many manners, for example, obtaining the data from the outside, or obtaining the data locally.

In an optional embodiment, the obtaining data corresponding to the attribute and the fingerprint information includes:

sending the attribute and the fingerprint information to a cloud server; and

receiving data corresponding to the attribute and the fingerprint information returned by the cloud server.

Specifically, an address of the cloud server may be preset in the interaction apparatus. A mapping table at the cloud server may store a mapping relationship of data with attributes and fingerprint information, thus the cloud server could provide, for many interaction apparatuses, a service for searching for data which is corresponding to an attribute and fingerprint information and then returning the data.

In another optional embodiment, the obtaining data corresponding to the attribute and the fingerprint information includes:

obtaining data corresponding to the attribute and the fingerprint information according to a local mapping table.

The local mapping table stores a mapping relationship of data with attributes and fingerprint information.

In the mapping table of any one of the foregoing embodiments, the mapping relationship of data to with attributes and fingerprint information may be diversified. Optionally, data corresponding to same fingerprint information and different attributes is different. For example, data corresponding to a fingerprint of the right middle finger of a user Zhang San and an email address attribute is an email address of the user Zhang San, and data corresponding to the fingerprint of the right middle finger of the user Zhang San and a password attribute is a password of the user Zhang San. Optionally, data corresponding to a same attribute and different fingerprint information is different. For example, data corresponding to a fingerprint of the right middle finger of a user Zhang San and an email address attribute is an email address A of the user Zhang San, and data corresponding to the fingerprint of the right index finger of the user Zhang San and an email address attribute is an email address B of the user Zhang San.

Optionally, after the obtaining data corresponding to the attribute and the fingerprint information, this embodiment further includes:

presenting the data on the user interface explicitly or implicitly.

Presenting the data explicitly refers to presenting real content of the data, and presenting the data implicitly refers to a presenting manner of hiding the real content of the data. For example, presenting a password implicitly may be presenting the password by replacing each character in the password with a specific graphic or symbol.

Specifically, the data may be presented in the area of the user interface explicitly or implicitly. For example, in a scenario where the area is a password input box and the corresponding attribute of the area in the user interface is password, the interaction apparatus obtains a password corresponding to the attribute and the fingerprint information, replaces each character in the password with “•” and presents “•” in the password input box.

This embodiment provides an interaction solution, especially an interaction solution using fingerprint information, by obtainings fingerprint information input by a user in an area in a user interface, determining a corresponding attribute of the area in the user interface, and obtaining data corresponding to the attribute and the fingerprint information, thereby ensuring both accuracy and convenience.

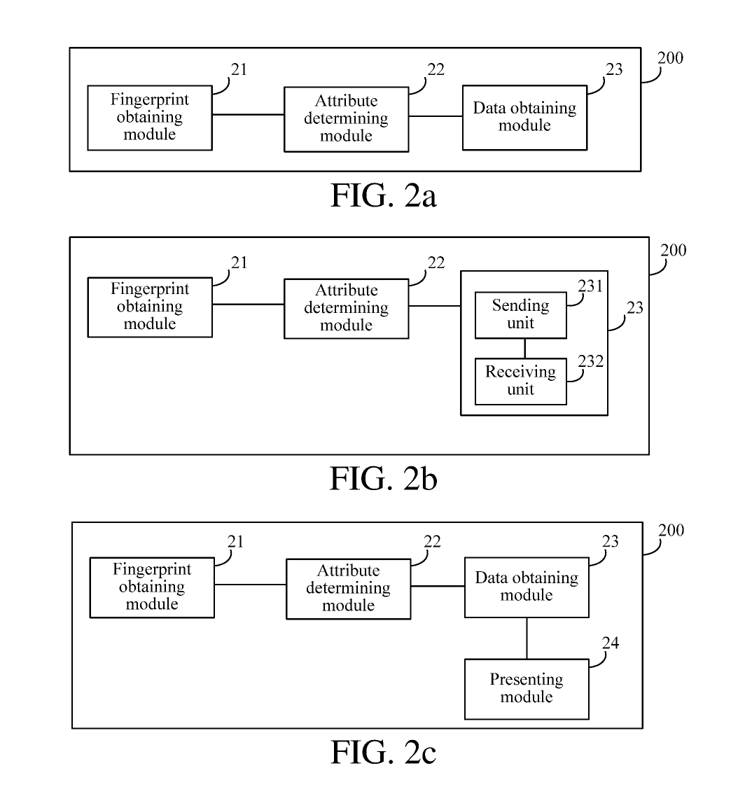

FIG. 2a is a structural diagram of an embodiment of an interaction apparatus according to the present application. As shown in FIG. 2a, an interaction apparatus 200 includes:

a fingerprint obtaining module 21, configured to obtain fingerprint information input by a user in an area in a user interface;

an attribute determining module 22, configured to determine a corresponding attribute of the area in the user interface; and

a data obtaining module 23, configured to obtain data corresponding to the attribute and the fingerprint information.

Specifically, the interaction apparatus 200 may be arranged in a user terminal in a form of hardware and/or software, or the interaction apparatus 200 is a user terminal; the user terminal includes, but is not limited to: a mobile phone, a tablet computer, or a wearable device.

Specifically, the user interface includes a software part and/or a hardware part that is provided by the interaction apparatus 200 or the user terminal in which the interaction apparatus 200 is arranged and implements information exchange between a user and the interaction apparatus 200 or the user terminal. In an optional embodiment, the user interface includes a page of an application. Specifically, the page is a page currently displayed by the interaction apparatus 200 or the user terminal. In another optional embodiment, the user interface includes a page of an application and an input apparatus, such as a keyboard or a touch screen.

Specifically, the area is an input area. For example, the area may be an input box on a page, or a content editing area, such as a text editing area on an email writing page.

In an optional embodiment, the fingerprint information is input by touch. Correspondingly, a user performs touch input htrough a touch input apparatus provided by the interaction apparatus or the user terminal, and the touch input apparatus may be a touch display screen, a fingerprint recognizer, or the like. Correspondingly, the fingerprint obtaining module 21 obtains the fingerprint information from the touch input apparatus. For example, the user terminal has a touch display screen, and the user can touch a position corresponding to an input area on a page currently displayed on the touch display screen with a finger. For another example, the user terminal has a keyboard that includes a fingerprint recognizer, and the user can touch the fingerprint recognizer of the keyboard when an input area on a currently displayed page is selected.

Specifically, the fingerprint information includes: at least one fingerprint. Each one of the at least one fingerprint is a complete fingerprint or a partial fingerprint. For example, when the user performs touch input with the fingertip of a finger, a fingerprint obtained by the fingerprint obtaining module 21 may be a partial fingerprint; when the user performs touch input with the finger pulp of a finger, a fingerprint obtained by the fingerprint obtaining module 21 may be a complete fingerprint. It should be noted that when the fingerprint information includes multiple fingerprints, the multiple fingerprints may include at least one complete fingerprint and at least one partial fingerprint at the same time, which is not limited by this embodiment.

In an optional embodiment, the fingerprint information further includes: a direction of each one of the at least one fingerprint. Usually, the direction refers to a relative direction of the fingerprint to the touch input apparatus. As shown in FIG. 1b and FIG. 1c, coordinate axes x and y in FIG. 1b and FIG. 1c are coordinate axes used for fingerprint acquisition by the touch input apparatus, the direction of the fingerprint in FIG. 1b is a y-axis direction, and the direction of the fingerprint in FIG. lc is an x-axis direction.

Further, when the fingerprint information includes multiple fingerprints, the fingerprint information further includes: an arrangement of the multiple fingerprints. Specifically, the arrangement includes, but is not limited to: order of the arrangement, and a shape of the arrangement. The multiple fingerprints may be same fingerprints, for example, the multiple fingerprints are same fingerprints when the user touches the area with a same finger many times, and may also be different fingerprints, for example, the multiple fingerprints are different fingerprints when the user touches the area with multiple fingers at the same time, or when the user touches the area with multiple fingers one by one, which is not limited by this embodiment.

Specifically, the attribute determined by the attribute determining module 22 includes, but is not limited to, one of the followings: address, password, date, name, account, phone number, content, and file. The address attribute may further be classified into email address, mailing address, and so on; the account attribute may further be classified into login account, bank account, and so on.

For example, in a scenario where the user interface is a login page of an email, when the area is an email address input box, the attribute determining module 22 determines that the corresponding attribute of the area in the user interface is email address; when the area is a password input box, the attribute determining module 22 determines that the corresponding attribute of the area in the user interface is password; when the area is an attachment adding box, the attribute determining module 22 determines that the corresponding attribute of the area in the user interface is file; when the area is a content editing area, the attribute determining module 22 determines that the corresponding attribute of the area in the user interface is content.

Usually, the data is data that matches the attribute. For example, when the corresponding attribute of the area in the user interface is phone number, the data is a phone number; when the corresponding attribute of the area in the user interface is email address, the data is an email address;

when the corresponding attribute of the area in the user interface is content, the data is a piece of content, such as a text or a signature.

Specifically, the data obtaining module 23 may obtain the data in many manners, for example, obtaining the data from the outside, or obtaining the data locally.

In an optional embodiment, as shown in FIG. 2b, the data obtaining module 23 includes:

a sending unit 231, configured to send the attribute and the fingerprint information to a cloud server; and

a receiving unit 232, configured to receive data corresponding to the attribute and the fingerprint information returned by the cloud server.

Specifically, an address of the cloud server may be preset in the interaction apparatus 200. A mapping table at the cloud server may store a mapping relationship of data with attributes and fingerprint, thus the cloud server could provide, for many interaction apparatuses, a service for searching for data which is corresponding to an attribute and fingerprint information and then returning the data.

In another optional embodiment, the data obtaining module 23 is specifically configured to: obtain data corresponding to the attribute and the fingerprint information according to a local mapping table.

The local mapping table stores a mapping relationship of data with attributes and fingerprint information.

In the mapping table of any one of the foregoing embodiments, the mapping relationship of data with attributes and fingerprint information may be diversified. Optionally, data corresponding to same fingerprint information and different attributes is different. For example, data corresponding to a fingerprint of the right middle finger of a user Zhang San and an email address attribute is an email address of the user Zhang San, and data corresponding to the fingerprint of the right middle finger of the user Zhang San and a password attribute is a password of the user Zhang San. Optionally, data corresponding to a same attribute and different fingerprint information is different. For example, data corresponding to a fingerprint of the right middle finger of a user Zhang San and an email address attribute is an email address A of the user Zhang San, and data corresponding to a fingerprint of the right index finger of the user Zhang San and an email address attribute is an email address B of the user Zhang San.

Optionally, as shown in FIG. 2c, the interaction apparatus 200 further includes: a presenting module 24, configured to present the data on the user interface explicitly or implicitly.

Presenting the data explicitly refers to presenting real content of the data, and presenting the data implicitly refers to a presenting manner of hiding the real content of the data. For example, when presenting a password implicitly, the presenting module 24 may present the password by replacing each character in the password with a specific graphic or symbol.

Specifically, the presenting module 24 may present the data in the area of the user interface explicitly or implicitly. For example, in a scenario where the area is a password input box and the corresponding attribute of the area in the user interface is password, the data obtaining module 23 obtains a password corresponding to the attribute and the fingerprint information, the presenting module 24 replaces each character in the password with “•” and presents “•” in the password input box.

This embodiment provides an interaction solution, and especially an interaction solution using fingerprint information, in which an interaction apparatus obtains fingerprint information input by a user in an area in a user interface, determines a corresponding attribute of the area in the user interface, and obtains data corresponding to the attribute and the fingerprint information, thereby ensuring both the accuracy and convenience.

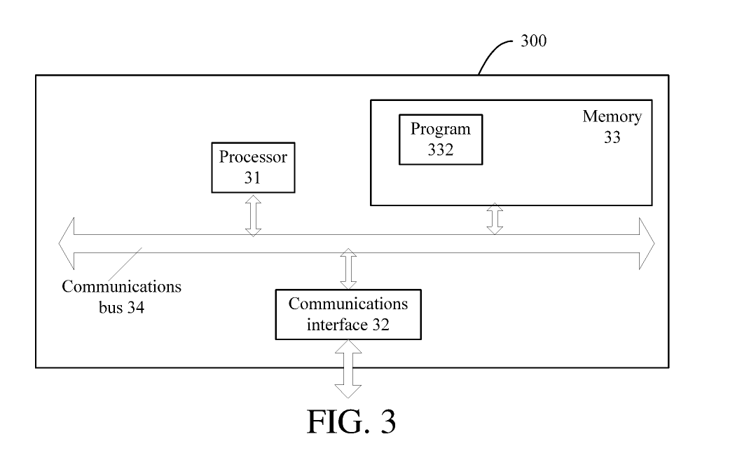

FIG. 3 is a structural diagram of Embodiment 2 of an interaction apparatus according to the present application. As shown in FIG. 3, an interaction apparatus 300 includes:

a processor 31, a communications interface 32, a memory 33, and a communications bus 34.

The processor 31, the communications interface 32 and the memory 33 communicate with each other by using the communications bus 34.

The communications interface 32 is configured to communicate with an external device such as a cloud server.

Further, the interaction apparatus 300 may further include a camera module, a microphone module, and so on, which are not shown in the figure.

The processor 31 is configured to execute a program 332, and specifically may execute relevant steps in the foregoing method embodiments.

Specifically, the program 332 may include program code, where the program code includes a computer operation instruction.

The processor 31 may be a central processing unit (CPU), or an application specific integrated circuit (ASIC), or may be configured as one or more integrated circuits that implement the embodiments of the present application.

The memory 33 configured to store the program 332. The memory 33 may include a high speed random access memory (RAM), also may further include a non-volatile memory, such as at least one disk memory. The program 332 may specifically be configured to enable the interaction apparatus 300 to execute the following steps:

obtaining fingerprint information input by a user in an area in a user interface;

determining a corresponding attribute of the area in the user interface; and

obtaining data corresponding to the attribute and the fingerprint information.

For specific implementation of the steps in the program 332, reference may be made to corresponding descriptions in corresponding steps and units in the foregoing interaction method embodiment, and details are not described herein again. It can be clearly known by a person skilled in the art that, to make the description convenient and concise, for specific working processes of the devices and modules described above, reference may be made to corresponding process descriptions in the foregoing interaction method embodiment, and details are not described herein again.

It can be realized by a person of ordinary skill in the art that, units and method steps described with reference to the embodiments disclosed in this specification can be implemented by electronic hardware or a combination of computer software and electronic hardware. Whether these functions are actually executed in a hardware or software form depends on specific applications and design constraints of the technical solution. A person skilled in the art may use different methods to implement the described function for each specific application, but such implementation should not be considered beyond the scope of the present application.

If the function is implemented in a form of a software functional unit and is sold or used as an independent product, the product can be stored in a computer-readable storage medium. Based on this understanding, the technical solution of the present application essentially, or a part of the technical solution that contributes to the prior art, or a part of the technical solution may be embodied in a form of a software product; the computer software product is stored in a storage medium and includes a number of instructions that enable a computer device (which may be a personal computer, a server, or a network device, or the like) to execute all or some of the steps of the method in the embodiments of the present application. The foregoing storage medium includes all kinds of mediums that can store program code, such as a USB flash drive, a mobile hard disk, a read-only memory (ROM), a RAM, a magnetic disk, or a compact disc.

The foregoing embodiments are only used to describe the present application, but not to limit the present application. A person of ordinary skill in the art can still make various alterations and modifications without departing from the spirit and scope of the present application; therefore, all equivalent technical solutions also fall within the scope of the present application, and the patent protection scope of the present application should be subject to the claims.

What is claimed is:

1. A method, comprising:
obtaining, by a device comprising a processor, fingerprint information input by a user in an area in a user interface;
determining a corresponding attribute of the area in the user interface; and
obtaining data corresponding to the corresponding attribute and the fingerprint information.

2. The method of claim 1, wherein the user interface comprises a page of an application.

3. The method of claim 1, wherein the area is an input area.

4. The method of claim 1, wherein the fingerprint information is input by touch.

5. The method of claim 1, wherein the fingerprint information comprises: at least one fingerprint.

6. The method of claim 5, wherein each one of the at least one fingerprint is a complete fingerprint or a partial fingerprint.

7. The method of claims 6, wherein the fingerprint information further comprises: a direction of each one of the at least one fingerprint.

8. The method of claim 6, wherein the fingerprint information comprises multiple fingerprints, and the fingerprint information further comprises: an arrangement of the multiple fingerprints.

9. The method of claim 1, wherein the attribute comprises: address, password, date, name, account, phone number, content or file.

10. The method of claim 1, wherein the obtaining the data corresponding to the corresponding attribute and the fingerprint information comprises:
sending the corresponding attribute and the fingerprint information to a cloud server; and
receiving the data corresponding to the corresponding attribute and the fingerprint information returned by the cloud server.

11. The method of claim 1, wherein the obtaining the data corresponding to the corresponding attribute and the fingerprint information comprises:
obtaining the data corresponding to the corresponding attribute and the fingerprint information according to a local mapping table.

12. The method of claim 1, further comprising, after the obtaining data corresponding to the attribute and the fingerprint information:
presenting the data on the user interface explicitly or implicitly.

13. An apparatus, comprising:
a processor, coupled to a memory, that executes or facilitates execution of executable modules, comprising:
a fingerprint obtaining module configured to obtain fingerprint information input by a user in an area in a user interface;
an attribute determining module configured to determine a corresponding attribute of the area in the user interface; and
a data obtaining module configured to obtain data corresponding to the corresponding attribute and the fingerprint information.

14. The apparatus of claim 13, wherein the user interface comprises a page of an application.

15. The apparatus of claim 13, wherein the area is an input area.

16. The apparatus of claim 13, wherein the fingerprint information is input by touch.

17. The apparatus of claim 13, wherein the fingerprint information comprises: at least one fingerprint.

18. The apparatus of claim 17, wherein each one of the at least one fingerprint is a complete fingerprint or a partial fingerprint.

19. The apparatus of claims 18, wherein the fingerprint information further comprises: a direction of each one of the at least one fingerprint.

20. The apparatus of claim 18, wherein the fingerprint information comprises multiple fingerprints, and the fingerprint information further comprises: an arrangement of the multiple fingerprints.

21. The apparatus of claim 13, wherein the corresponding attribute comprises: an address, a password, a date, a name, an account, a phone number, content or a file.

22. The apparatus of claim 13, wherein the data obtaining module comprises:
a sending unit configured to send the corresponding attribute and the fingerprint information to a cloud server; and
a receiving unit configured to receive the data corresponding to the corresponding attribute and the fingerprint information returned by the cloud server.

23. The apparatus of claim 13, wherein the data obtaining module is configured to: obtain the data corresponding to the corresponding attribute and the fingerprint information according to a local mapping table.

24. The apparatus of claim 13, wherein the executable modules further comprise: a presenting module configured to present the data on the user interface explicitly or implicitly.

25. A computer readable storage device comprising executable instructions that, in response to execution, cause a device comprising a processor to perform operations, comprising:
obtaining fingerprint information input by a user in an area in a user interface;
determining a corresponding attribute of the area in the user interface; and
obtaining data corresponding to the corresponding attribute and the fingerprint information.
